(19) United States
(12) Patent Application Publication
(10) Pub. No.: US 2026/0062001 A1
(43) Pub. Date: Mar. 5, 2026

(54) METHODS FOR CONTROLLING THE DRIVING OPERATION OF A VEHICLE

(71) Applicants: CARIAD SE, Wolfsburg (DE); Robert Bosch GmbH, Stuttgart (DE)

(72) Inventor: Jonas Klandt, Wolfsburg (DE)

(21) Appl. No.: 19/313,356

(22) Filed: Aug. 28, 2025

(30) Foreign Application Priority Data
Aug. 29, 2024 (DE) 10 2024 124 754.1

(51) Int. Cl. B60W 30/095; B60W 30/06; B60W 30/09; G06V 10/764; G06V 20/58

(52) U.S. Cl. CPC B60W 30/0956; B60W 30/06; B60W 30/09; G06V 10/764; G06V 20/58; B60W 2420/403; B60W 2554/60

(57) ABSTRACT

The disclosure relates to a method for controlling a driving operation of a vehicle. According to the method, sensor data of a monitoring area in front of the vehicle is captured and environmental images of an environment of the vehicle are captured. Based on the sensor data and the environmental images, objects are optically identified and classified into known objects and unknown objects. A degree of passability is associated with the known objects. The unknown objects are further processed by input of their pictures into a computing unit configured with the degree of passability of objects. The unknown objects are identified and a degree of passability is associated with them. This degree of passability for the unknown objects is provided to a control unit and the driving operation of the vehicle is controlled by it by using the degree of passability of the objects and the unknown objects.

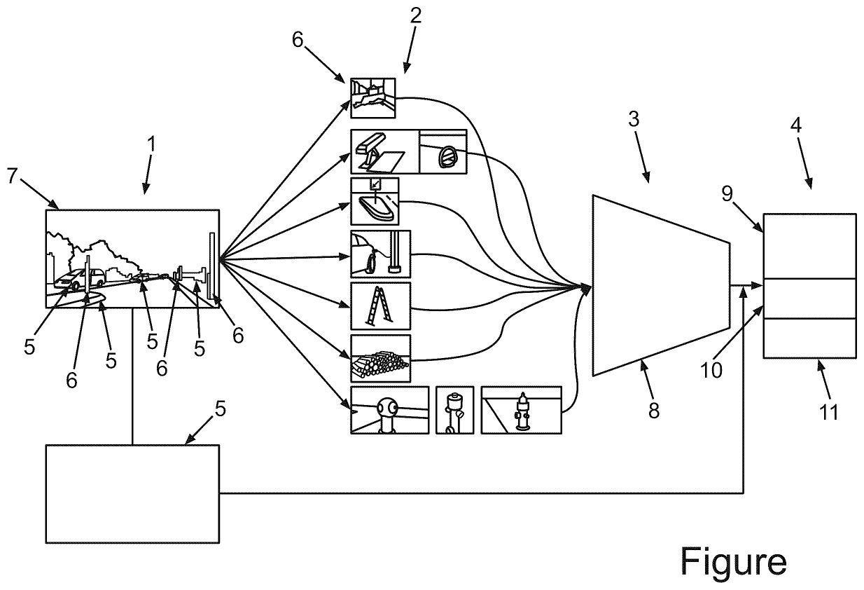

### BACKGROUND

### Technical Field

The disclosure relates to a method for controlling the driving operation of a vehicle.

### Description of the Related Art

In vehicles, assistance systems are employed to increasing extent for controlling the driving operation of the vehicle to assist or relieve the driver of the vehicle in certain driving situations or in certain motion processes of the vehicle. In the meantime, such assistance systems are in use in vehicles in diverse embodiments, for example as electronic stability programs like Electronic Stability Program (ESP) or Electronic Stability Control (ESC), as emergency brake assist, as lane keeping assist, as overtaking assist, as turn assist, as start assist, as congestion assist, as parking assist or for longitudinal control of the vehicle for example by way of a distance assist Adaptive Cruise Control (ACC), in which, depending on the speed of the own vehicle often referred to as ego vehicle, a desired distance of the ego vehicle to a preceding vehicle can be adjusted.

In context of the control of the driving operation of an ego vehicle, a method for determining a drivable free space for autonomous vehicles is known from DE 11 2019 000 048 T5. This drivable free space can give an indication of where the vehicle is able to maneuver without hitting objects, structures and/or the like. In exceptional cases such as for example in emergency situations, a passable boundary can be passed to penetrate into a potentially not drivable space such as for example onto a sidewalk or onto a lawn surface.

Further, a method for providing classified digital captures for a system for automatic machine learning and for updating a machine-readable program code is described in DE 10 2021 207 093 A1 hereto. Herein, a plurality of classes is preset, which characterize various object types. For example, a first such class characterizes objects, which are passable, and a second such class characterizes objects, which are not passable.

### BRIEF SUMMARY

The disclosure is based on the object to specify a method for controlling the driving operation of a vehicle, in which the vehicle is simply and reliably operated in compliance with safety aspects upon occurrence of objects in the front field of the vehicle.

In the method according to the disclosure for controlling the driving operation of a vehicle, during the drive of the vehicle, the front field of the vehicle and in particular the area in front of the vehicle in driving direction is first sensed by way of at least one sensor of the vehicle for determining relevant objects in the front field of the vehicle and in particular in front of the vehicle in driving direction, whereby corresponding sensor data of the at least one sensor of the vehicle is ascertained. Based on this sensor data of the at least one sensor, the relevant objects in the front field of the vehicle and in particular in front of the vehicle in driving direction are then determined. Furthermore, the environment of the vehicle is optically captured by way of at least one camera of the vehicle for permanent generation of environmental images. The ascertained relevant objects in the front field of the vehicle and in particular in front of the vehicle in driving direction are now in particular optically identified based on the sensor data and the environmental images. This optical identification of the relevant objects in the front field of the vehicle and in particular in front of the vehicle in driving direction is effected in a control unit of the vehicle by using point clouds obtained from the sensor data of the sensors. The relevant objects are ascertained as elevations in the point clouds and identified by association of the respective point cloud with the environmental images of the at least one camera by the control unit of the vehicle. The positions of the relevant objects and thereby of the elevations in the point clouds are determined based on coordinates such that the coordinates of the point clouds and the elevations ascertained therein are compared to the coordinates of the environmental images generated by at least one camera as a reference.

Based on the picture of the identified relevant objects provided by the at least one camera in the environmental images, these identified relevant objects are divided into known relevant objects and into unknown relevant objects and thereby correspondingly classified. A degree of passability known for these objects and already set is associated with the known relevant objects. That is, a degree of passability or status of passability stored in the control unit and previously set for these known relevant objects is associated with the identified known relevant objects, such as for example traffic signs, vehicles, sidewalks, curbs, etc., by the control unit. For example, the identified known relevant objects get associated the status of passability or degree of passability “passable easily” or get associated the status of passability or degree of passability “passable difficultly” or the general status of passability or degree of passability “passable yes” and thereby a positive status of passability or the general status of passability or degree of passability “passable no” and thereby a negative status of passability.

The relevant objects identified, but classified as unknown are further processed, wherein the relevant objects classified as unknown can be successively and thereby consecutively further processed, or multiple relevant objects classified as unknown are further processed at the same time. For further processing the unknown relevant objects, the relevant objects classified as unknown are supplied to a specially configured computing unit or database in the vehicle in the form of pictures, which has been configured with model parameters characterizing the degree of passability of objects. Accordingly, this computing unit or database processing the relevant objects classified as unknown obtains a specially configured processing model as an image-to-text model, which solely includes the degree of passability of model items and solely processes and evaluates the degree of passability of model items. For example, as the degree of passability of model items, the computing unit or database can associate either the degree of passability “passable” or associate the degree of passability “non-passable” with these model items. Hereto, describing text is associated with the picture of the respective relevant object classified as unknown, based on which the characteristics of the respective relevant object classified as unknown are derived by the computing unit or database or are determined by using the contents recorded in the computing unit or database. Herein, the designation of the respective relevant object classified as unknown can optionally also be ascertained and output by the computing unit in the vehicle in suitable manner.

The degree of passability associated with the unknown relevant objects is transferred to the control unit of the vehicle by the computing unit such that the degree of passability for all relevant objects in the front field of the vehicle and in particular in front of the vehicle in driving direction is thereby known to the control unit.

Based on the degree of passability present in the control unit of the vehicle for all relevant objects in the front field of the vehicle and in particular in front of the vehicle in driving direction, the driving operation of the vehicle is controlled by the control unit by using the degree of passability of all relevant objects.

For example, evasive maneuvers of the vehicle, parking operations of the vehicle or similar driving maneuvers of the vehicle can be controlled with the indications to the degree of passability present for all relevant objects in the front field of the vehicle and in particular in front of the vehicle in driving direction.

In an advantageous development of the disclosure, the point clouds representing the relevant objects are directly generated by a respective sensor of the vehicle as sensor data or the point clouds representing the relevant objects are indirectly generated based on the sensor data. This means that the point clouds representing relevant objects can either already be generated directly by the sensors of the vehicle themselves, for example by radar sensors and/or by ultrasonic sensors and/or by lidar sensors of the vehicle. Or the point clouds representing relevant objects are derived based on the sensor data of optical sensors like cameras and the camera images thereof in that the point clouds are generated from the difference formation of at least two camera images.

In an advantageous development of the disclosure, the computing unit is configured with a low number of model parameters of the processing model characterizing the degree of passability of objects. That is, a “small” efficient and lean processing model with a significantly low number of model parameters is employed in the method according to the disclosure. This processing model is trained by a master unit comprising a large number of model parameters with respect to the processing procedure to thereby replicate the behavior of the master unit. Herein, the processing pattern or processing scheme, the intermediate steps or intermediate representations in the model calculation and thereby in the processing as well as the output values of the master unit are in particular imitated by the processing model. The efficient processing model correspondingly trained for the special task of ascertaining the degree of passability of objects is employed in the computing unit for further processing the unknown relevant objects.

In this further processing of the unknown relevant objects, the picture of the respective unknown relevant objects is input into the computing unit configured with the degree of passability of objects and thereby into the processing model present there. Herein, the length of the input of data input into the processing model and to be processed by this processing model can be kept low, in particular with respect to the image input of the unknown relevant objects into the computing unit and thereby into the processing model present there.

Since the input into the computing unit is focused to the desired determination of a set and already localized relevant object in the respective environmental image or in the front field of the vehicle and in particular in front of the vehicle in driving direction, the complexity or amount of data can be kept low in the data input into the computing unit and be significantly reduced with respect to other processing models. Due to the previous knowledge that only one certain image of an object is relevant to the processing, the picture of the respective unknown relevant objects can in particular be input as a uniform picture into the computing unit configured with the degree of passability of objects in the further processing of the unknown relevant objects. That is, the picture of the respective unknown relevant objects, hereby, does not have to be divided in the data input into the computing unit, whereby computing power is significantly saved and the processing speed in the computing unit or in the processing model is significantly increased due to the substantially lower number of calculations.

Herein, the method according to the disclosure is in particular employed in an assistance system of the vehicle, which performs an autonomous motion process of the vehicle and in particular a longitudinal guidance or longitudinal control of the vehicle and/or a transverse guidance or transverse control of the vehicle, such as for example an ACC system (Adaptive Cruise Control System) of the vehicle as the assistance system of the vehicle. Hereto, the assistance system of the vehicle comprises at least one control unit, at least one sensor system with at least one sensor for generating sensor data, at least one camera for generating environmental images and a computing unit for determining the degree of passability of objects. The data with respect to the degree of passability of relevant objects provided to the control unit is then correspondingly processed and employed for controlling the assistance system by the control unit.

The mentioned control units or control devices or control modules of the assistance system can comprise a data processing device or a processor device, which is configured to perform one of the described inventive features. Hereto, the processor device can comprise at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can respectively be used as the microprocessor. Furthermore, the processor device can comprise a program code, which is configured to perform the execution of one of the described inventive features upon execution by the processor device. The program code can be stored in a data memory of the processor device. The processor device can for example be integrated on at least one circuit board and/or on at least one SoC (System on Chip).

Further, a vehicle is also disclosed, which comprises at least one such assistance system. Thereby, a vehicle with an assistance system according to the disclosure also belongs to the disclosure, wherein the vehicle with the assistance system according to the disclosure can in particular be formed as a motor vehicle or automobile, in particular as a passenger car, or as a truck or as a passenger bus.

In the method according to the disclosure, certain traffic situations are taken into account, in which a particular assistance demand is given in operating the vehicle due to special circumstances. According to the disclosure, these particular motion processes of the vehicle are thus advantageously in particular also controlled in simple manner in compliance with safety aspects.

### BRIEF DESCRIPTION OF THE SEVERAL VIEWS OF THE DRAWING

In the following, an embodiment of the disclosure is described. Hereto, the FIGURE shows a schematic representation of certain method acts in performing the method according to the disclosure.

### DETAILED DESCRIPTION

The embodiment explained in the following is an advantageous embodiment of the disclosure. In the embodiment, the described components each represent individual features of the disclosure to be considered independently of each other, which also each develop the disclosure independently of each other and thereby are also to be regarded as a constituent of the disclosure in individual manner or in a combination different from the shown one. Furthermore, the described embodiment can also be supplemented by further ones of the already described features of the disclosure.

In the FIGURE, a schematic overview of acts of the method according to the disclosure is illustrated. Herein, a vehicle with diverse sensor systems with sensors for data capture and with assistance systems for assisting the driver of the vehicle moves on a driving route.

In a first method step 1, the environment located in front of the vehicle in driving direction is sensed as a monitoring area for example by way of radar sensors of a radar system for data capture, whereby point clouds with measurement points are successively generated as sensor data. In these point clouds, certain elevations become apparent, which are evaluated as relevant objects 5, 6 in the environmental area and in particular in driving direction of the vehicle. In one or more implementations, a size of each of the relevant objects 5, 6 is greater than or equal to a predetermined size threshold. At the same time, environmental images 7 of the environment of the vehicle are captured by a camera of the vehicle during the drive of the vehicle, in which certain relevant objects 5, 6 are also represented. By a respective comparison of a “sensor image” obtained based on the sensor data and the corresponding environmental image 7 matching it, an association and mapping of the relevant objects 5, 6 in the environmental area of the vehicle and in particular in driving direction of the vehicle is effected. These relevant objects 5, 6 are differentiated into known relevant objects 5 and into unknown relevant objects 6 and correspondingly classified by an evaluation unit in the vehicle. Herein, in particular other vehicles, traffic signs, traffic islands, sidewalks or traffic light poles come into consideration as known relevant objects 5. Of these known relevant objects 5, the degree of passability 9 thereof is also known, that is, if these known relevant objects 5 and with which difficulty these known relevant objects 5 can be passed. For example, either the degree of passability 9 “passable yes” is associated with the known relevant objects 5 as passability 10, for example traffic islands or grassed areas, which can be passed by a vehicle in case of emergency, or the degree of passability 9 “passable no” is associated as non-passability 11, for example traffic lights or traffic signs, which cannot be passed by a vehicle even in case of emergency. The known relevant objects 5 are supplied to a control unit of the vehicle with their respective degree of passability 9, for example to a control device of an assistance system of the vehicle.

In a further method step 2, the unknown relevant objects 6 are identified and classified in that they are supplied to a specially configured database as the computing unit 8 in the vehicle in image form as a uniform picture. For example, hydrants, deposited objects like ladders or toolboxes, temporary lane information boards like delineators, etc., come into consideration as unknown relevant objects 6.

In the method step 3, processing of the identified and classified unknown relevant objects 6 in the specially configured database as the computing unit 8 in the vehicle is effected. By this database specified and trained to the association and the output of the degree of passability of objects as the computing unit 8 in the vehicle, a fast processing can be effected due to the specialization and focusing thereof to this one task after the input of the unknown relevant objects 6. Herein, a degree of passability 9 is also associated with the unknown relevant objects 6 by the database as the computing unit 8 in the vehicle, that is if these unknown relevant objects 6 and with which difficulty these unknown relevant objects 6 can be passed. For example, either the degree of passability 9 “passable yes” as passability 10, for example ladders or toolboxes, which can be passed by a vehicle in case of emergency, or the degree of passability 9 “passable no” as non-passability 11, for example hydrants, which cannot be passed by a vehicle even in case of emergency, is also associated with the unknown relevant objects 6. The unknown relevant objects 6 now identified and classified too are supplied with their respective degree of passability 9 to the control unit of the vehicle, for example to the mentioned control device of an assistance system of the vehicle. Optionally, the unknown relevant objects 6 now identified and classified can be output by an assistance system or a display system of the vehicle additionally with their respective designation to a driver of the vehicle and for example also be displayed with their respective designation to a driver of the vehicle.

In the method step 4, the degree of passability 9 now associated with all relevant objects 5, 6, that is either the degree of passability 9 “passable yes” as passability 10 or the degree of passability 9 “passable no” as non-passability 11 for the relevant objects 5, 6, is used by at least one assistance system of the vehicle for controlling the driving operation of the vehicle. For example, this information of the degree of passability 9 can be used within the scope of an assisted driving operation or within the scope of an automated driving operation or within the scope of an autonomous driving operation for calculating and performing evasive maneuvers of the vehicle upon occurrence of a case of emergency in the driving operation of the vehicle.

German patent application no. 102024124754.1, filed Aug. 29, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled

1. A method for controlling a driving operation of a vehicle, the method comprising:
capturing sensor data of a monitoring area in front of the vehicle in a driving direction by way of at least one sensor of the vehicle;
optically capturing environmental images of an environment of the vehicle by way of at least one camera of the vehicle;
optically identifying relevant objects in front of the vehicle in the driving direction based on the sensor data and the environmental images;
classifying the relevant objects based on the sensor data and/or based on a picture of one or more of the relevant objects into known relevant objects and into unknown relevant objects;
associating a degree of passability with the known relevant objects, wherein the degree of passability is stored in a control unit;
further processing the unknown relevant objects by inputting a picture of each of the unknown relevant objects into a computing unit that estimates the degree of passability of objects,
identifying the unknown relevant objects and associating the degree of passability for the unknown relevant objects by the computing unit and providing the degree of passability for the unknown relevant objects to the control unit, and
controlling the driving operation of the vehicle by the control unit using the degree of passability of the known relevant objects and the unknown relevant objects.

2. The method according to claim 1, further comprising:
generating point clouds representing objects by the at least one sensor of the vehicle as the sensor data or based on the sensor data.

3. The method according to claim 1, wherein the computing unit is configured with a number of model parameters characterizing the degree of passability of objects.

4. The method according to claim 1, wherein the computing unit adopts, from a master unit comprising a plurality of model parameters, a processing procedure of the master unit in determining the degree of passability of objects and the computing unit applies the processing procedure in the further processing of the unknown relevant objects.

5. The method according to claim 4, wherein, in the further processing of the unknown relevant objects by the computing unit, only the picture of each of the unknown relevant objects is input into the computing unit configured with the model parameters characterizing the degree of passability of objects and imitating the processing procedure of the master unit.

6. The method according to claim 5, wherein, in the further processing of the unknown relevant objects, a uniform and non-divided picture of each of the unknown relevant objects is input into the computing unit.

7. The method according to claim 1, wherein the driving operation of the vehicle is controlled by the control unit by using the degree of passability of the known relevant objects and the unknown relevant objects, and wherein the driving operation includes an evasive maneuver of the vehicle and/or a parking operation of the vehicle.

8. The method according to claim 1, wherein the degree of passability associated with each relevant object of the relevant objects indicates whether the relevant object is passable or not passable.

9. An assistance system of a vehicle, the assistance system comprising:
at least one control unit;
at least one sensor system including at least one sensor that, in operation, generates sensor data;
at least one camera that, in operation, generates environmental images; and
a computing unit that, in operation, determines degree of passability of objects,
wherein the computing unit, in operation,
optically identifies relevant objects in front of the vehicle in a driving direction based on the sensor data and the environmental images;
classifies the relevant objects based on the sensor data and/or based on a picture of one or more of the relevant objects into known relevant objects and into unknown relevant objects;
associates a degree of passability with the known relevant objects, wherein the degree of passability is stored in a control unit;
further processes the unknown relevant objects by inputting a picture of each of the unknown relevant objects into a computing unit that estimates the degree of passability of objects,
identifies the unknown relevant objects and associating the degree of passability for the unknown relevant objects by the computing unit and providing the degree of passability for the unknown relevant objects to the control unit, and
controls a driving operation of the vehicle using the degree of passability of the known relevant objects and the unknown relevant objects.

10. A vehicle comprising:
the assistance system according to claim 9.
